(19) United States
(12) Patent Application Publication
(10) Pub. No.: US 2011/0050615 A1
(43) Pub. Date: Mar. 3, 2011

(54) PROCESSING CIRCUIT FOR DETERMINING TOUCH POINTS OF TOUCH EVENT ON TOUCH PANEL AND RELATED METHOD

(76) Inventor: Tung-Ke Wu, Taipei City (TW)

(21) Appl. No.: 12/870,855

(22) Filed: Aug. 30, 2010

(30) Foreign Application Priority Data
Sep. 3, 2009 (TW) 098129674

(51) Int. Cl. G06F 3/041

(52) U.S. Cl. 345/173

(57) ABSTRACT

A processing circuit for determining a touch point of a touch event on a touch control panel includes a plurality of sensing electrodes of the touch control panel, which generates a plurality of sensing signals in response to the touch event, respectively, and generates a plurality of sensing outputs according to differences of the plurality of sensing signals. The processing circuit includes a storage unit and a computation unit. The storage unit stores a plurality of known parameters, wherein the plurality of known parameters includes hardware parameters of at least one sensing electrode within the plurality of the sensing electrodes and signal parameters corresponding to at least one sensing output within the plurality of sensing outputs. The computation unit is coupled to the storage unit, and is for determining the touch point of the touch event according to the plurality of the sensing outputs and the plurality of known parameters.

### BACKGROUND OF THE INVENTION

1. Field of the Invention

The present invention relates to touch control technique, and more particularly, to a processing circuit of determining touch points on a touch panel and a method thereof.

2. Description of the Prior Art

In modern electronic merchandise, touch panels are very easy to handle such that they are commonly utilized as communication interfaces between users and machines. Among touch panels, a projective capacitive touch panel is widely exploited in portable devices (e.g. cell phones, and navigators for mobile vehicles) due to features such as multi-touch functionality, higher light transmittance, low power consumption, etc. However, when projective capacitance is utilized in measurement of a touch panel, there are only as many as a dozen sensing electrodes in a horizontal axis direction or in a vertical axis direction; in addition, when the projective capacitance is applied on a larger panel, a processor with a faster processing speed and a large amount of memory are required. Regarding the conventional technique, a calculation of a touch point is usually performed via interpolation, by determining an estimated peak value from sensing outputs measured by sensing electrodes, or estimating a distance between a measurement point and the extreme value by a ratio of the measured sensing output to the extreme value. The conventional touch point determination methods mentioned above not only require a huge amount of computation, however, but also need to be improved in accuracy.

### SUMMARY OF THE INVENTION

In light of this, the present invention provides a processing circuit capable of determining a touch point of a touch event on a touch panel quickly and accurately. A plurality of sensing electrodes of the touch control panel generates a plurality of sensing outputs in response to the touch event. The processing circuit includes a storage unit and a computation unit. The storage unit stores a plurality of known parameters, wherein the plurality of known parameters comprises hardware parameters of at least one sensing electrode within the plurality of the sensing electrodes and signal parameters corresponding to at least one sensing output within the plurality of sensing outputs. The computation unit is for determining the touch point of the touch event according to the plurality of the sensing outputs and the plurality of known parameters.

The present invention further provides a processing method for determining a touch point of a touch event on a touch control panel, wherein a plurality of sensing electrodes of the touch control panel generates a plurality of sensing signals in response to the touch event and generates a plurality of sensing outputs according to difference of the sensing signals. The processing method includes: storing a plurality of known parameters, wherein the plurality of known parameters comprises hardware parameters of at least one sensing electrode within the plurality of the sensing electrodes and signal parameters corresponding to at least one sensing output within the plurality of sensing outputs; and determining the touch point of the touch event according to the plurality of the sensing outputs and the plurality of known parameters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a processing circuit for processing sensing outputs of a touch panel according to an embodiment of the present invention.

FIG. 2 is a diagram of characteristic curves of sensing signals and corresponding sensing outputs generated by sensing electrodes according to an embodiment of the present invention.

FIG. 3 is a diagram of characteristic curves of sensing signals and corresponding sensing outputs generated by sensing electrodes according to another embodiment of the present invention.

FIG. 4 is a diagram of characteristic curves of partial sensing outputs of a touch panel when a touch event occurs according to an embodiment of the present invention.

FIG. 5 is a diagram of characteristic curves of partial sensing outputs of a touch panel when a touch event occurs according to another embodiment of the present invention.

FIG. 6 is a diagram of a common touch panel in a practical implementation.

FIG. 7 is a diagram of characteristic curves of partial sensing outputs of a touch panel when a touch event occurs according to another embodiment of the present invention.

### DETAILED DESCRIPTION

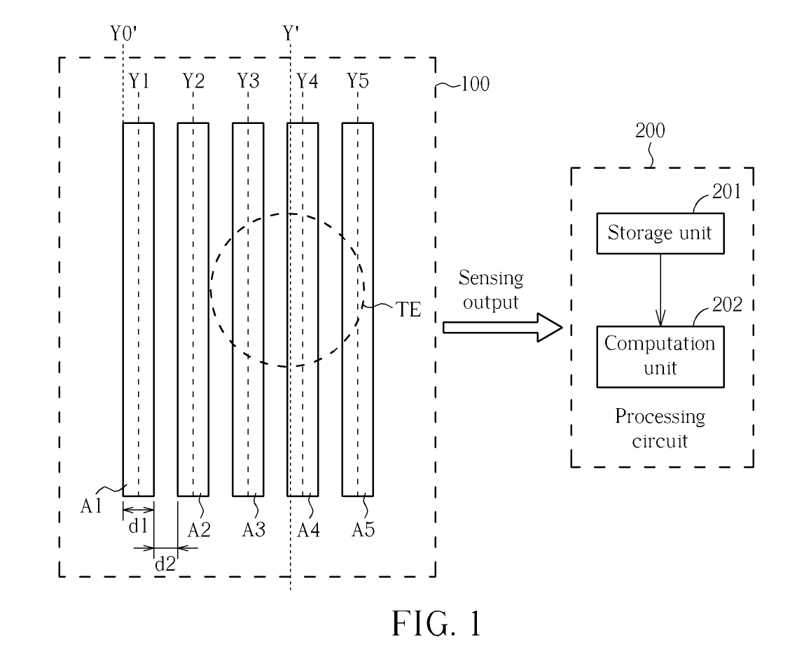

Please refer to FIG. 1, which is a diagram illustrating a processing circuit for processing sensing outputs of a touch panel according to an embodiment of the present invention. The touch panel 100 includes (but is not limited to) a plurality of sensing electrodes. For clarity and simplicity, FIG. 1 only illustrates five sensing electrodes 101˜105 without affecting disclosure of the present invention, wherein centers of the sensing electrodes 101˜105 are located at five locating axes Y1˜Y5, respectively; in addition, a width of each sensing electrode is d1, and a distance between two neighboring electrode is d2. Each electrode within the touch panel 100 will generate a corresponding sensing signal according to a touch event (in FIG. 1, the touch event, such as a finger of the user touching the touch panel 100, is represented by a dotted-line circle TE), and a plurality of sensing outputs are derived from differences of the sensing signals. In this embodiment, the processing circuit 200 includes a storage unit 201 and a computation unit 202. The storage unit 201 stores a plurality of known parameters, wherein the known parameters include hardware parameters of at least one sensing electrode of the sensing electrodes A1˜A5 and corresponding signal parameters of at least one sensing output of the sensing outputs. The computation unit 202 is coupled to the storage unit 201, and is for determining the touch point of the touch event, i.e., the center of the dotted-line circle, according to the plurality of the sensing outputs and the plurality of known parameters.

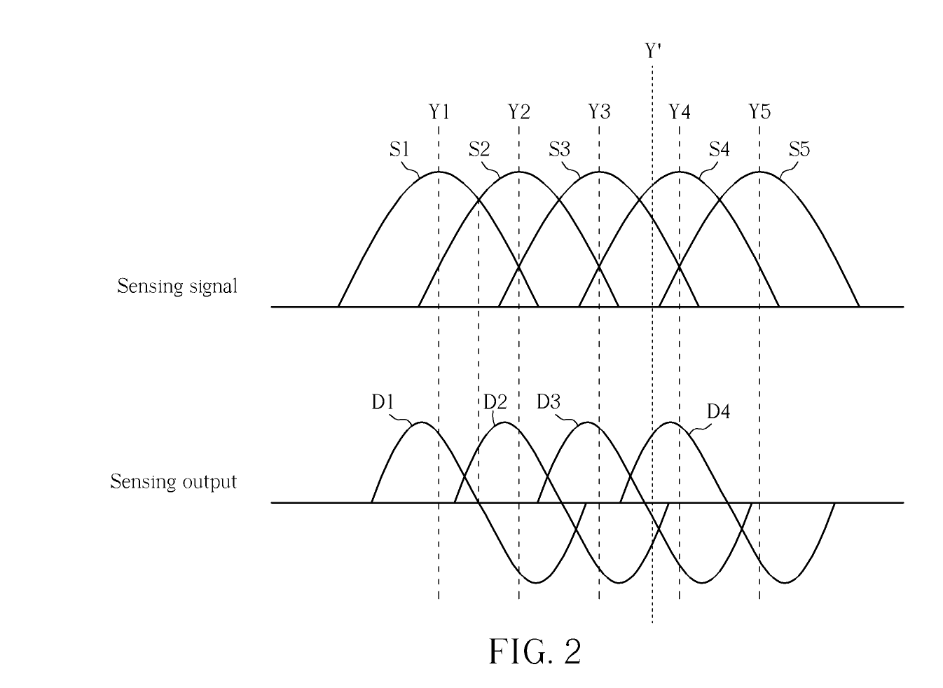

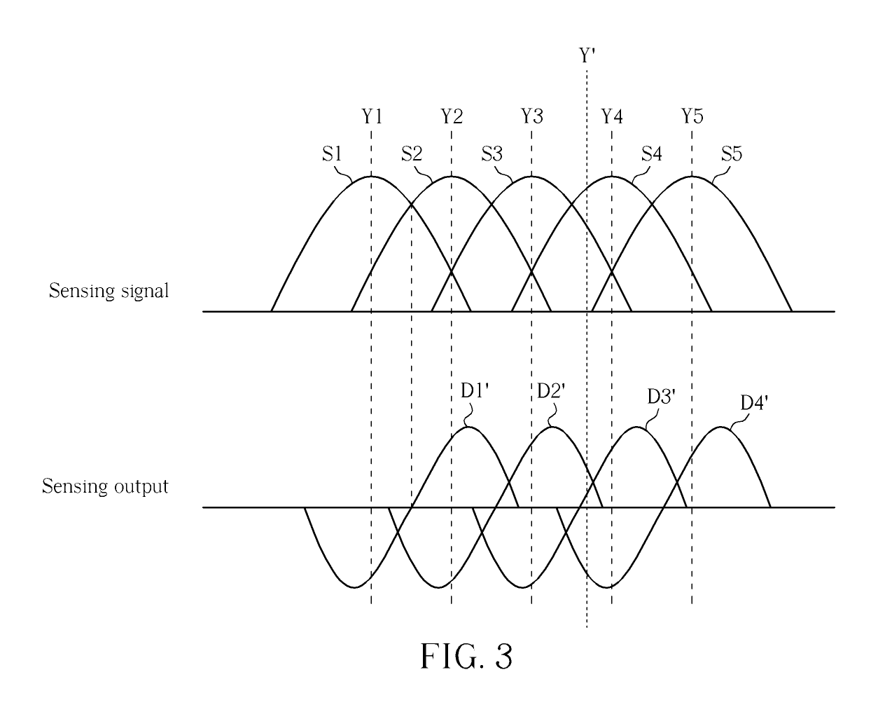

Please refer to FIG. 2, which is a diagram of characteristic curves of the sensing signals S1˜S5 and the corresponding sensing outputs D1˜D4 generated by the sensing electrodes A1˜A5 under the occurrence of a touch event according to an embodiment of the present invention. In this embodiment, the characteristic curves of sensing outputs D1˜D4 are generated from differences of the sensing signals S1˜S5. For example, the characteristic curve of the sensing output D1 is generated by the sensing signal S1 minus the sensing signal S2, the characteristic curve of the sensing output D2 is generated by the sensing signal S2 minus the sensing signal S3, and so on. As a result, a zero point of the characteristic curve of each sensing output indicates a center point of two neighboring sensing electrodes (i.e., the sensing signals of the two neighboring sensing electrodes generated by a touch point at the zero point are of the same magnitude). For example, the zero point of the characteristic curve of the sensing output D2 indicates a center point between the sensing electrodes A2 and A3. In addition, the characteristic curve around the zero point of the characteristic curve of each sensing output has favorable linearity. Please note that the aforementioned generating method of characteristic curves of the sensing outputs is only an illustrative embodiment, and is not supposed to be a limitation of the present invention. For example, the characteristic curve of a sensing output Dn is not necessarily limited to be generated by a difference of two neighboring sensing signals Sn−Sn+1 (a characteristic curve of the sensing output generated thereof has a negative slope around its zero point); alternatively, the characteristic curve of the sensing output Dn may be generated by a difference of another two neighboring sensing signals Sn−Sn−1 (a characteristic curve of the sensing output generated thereof has a positive slope around its zero point), as shown by the sensing outputs D1′˜D4′ in FIG. 3. As long as the outcome is substantially the same, this kind of variation in design also falls within the scope of the present invention.

In addition, in the embodiment of FIG. 1, the processing circuit 200 is coupled externally to the touch panel 100; however, this is for illustrative purposes only, and is not meant to be a limitation of the present invention. In other embodiments, the processing circuit 200 can also be integrated in the touch panel 200. This kind of variation in design also falls within the scope of the present invention.

In a practical implementation, the touch panel 100 in an embodiment will derive a plurality of characteristic curves of the sensing outputs D1˜D4 as shown in FIG. 2 via some touch tests, and store known parameters, such as hardware parameters like a width d1 of each sensing electrode and a distance d2 between two neighboring sensing electrodes (in this example, a distance between centers of two neighboring sensing electrodes is d1+d2) as well as a slope SP around the zero point of the characteristic curve of each of the sensing outputs D1˜D4 (in this example, the slope SP is a negative slope) in the storage unit 201 for following computation. Please note that, in this embodiment, the width d1, the distance d2 between neighboring sensing electrodes and the slope SP around the zero point of the characteristic curve of each sensing output have fixed values, respectively. In a practical implementation, however, regarding the sensing electrodes, their corresponding sensing electrode widths, distances each between neighboring sensing electrodes and slopes each around zero point of the corresponding characteristic curve may be different from each other. Thus, the storage unit 201 may also store known parameters corresponding to each sensing electrode, thereby allowing the computation unit 202 to derive a more accurate computation result.

Likewise, in another embodiment, the touch panel 100 will derive a plurality of characteristic curves of the sensing outputs D1′˜D4′ as shown in FIG. 3 via some touch tests, and store known parameters, such as hardware parameters like a width d1 of each sensing electrode and a distance d2 between two neighboring sensing electrodes (in this example, a distance between centers of two neighboring sensing electrodes is d1+d2) as well as a slope SP′ around the zero point of the characteristic curve of each of the sensing outputs D1′˜D4′ (in this example, the slope SP′ is a positive slope) in the storage unit 201 for following computation. Please note that, in this embodiment, the width d1, the distance d2 between neighboring sensing electrodes and the slope SP′ around the zero point of the characteristic curve of each sensing output have fixed values, respectively. In a practical implementation, however, regarding the sensing electrodes, their corresponding sensing electrode widths, distances each between neighboring sensing electrodes and slopes each around zero point of the corresponding characteristic curve may be different from each other. Thus, the storage unit 201 may store known parameters corresponding to each sensing electrode, thereby allowing the computation unit 202 to derive a more accurate computation result.

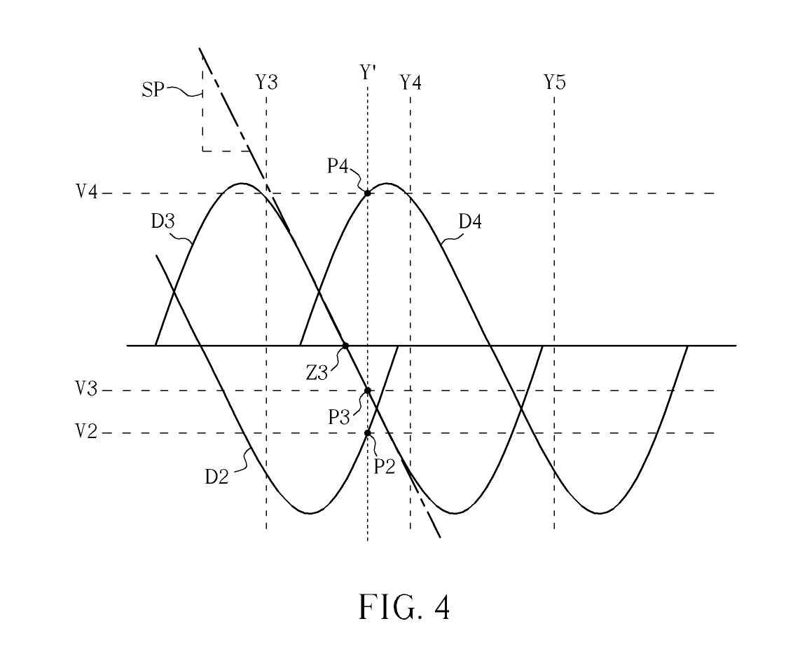

Please refer to FIG. 4 in conjunction with FIG. 1 for a further illustration of an operation of the present invention, wherein FIG. 4 is a diagram of characteristic curves of partial sensing outputs of the touch panel 100 under the occurrence of a touch event according to an embodiment of the present invention. Assume that, in FIG. 1, a center of the dotted-line circle TE corresponding to the touch event is located on a locating axis Y′ between the sensing electrode Y3 and the sensing electrode Y4. It can be seen from FIG. 4 that the locating axis Y′ has three intersection points P2, P3, P4 with characteristic curves of sensing outputs D2, D3, D4 corresponding to sensing electrodes A2, A3, A4, respectively, where the sensing electrodes have sensing output values V2, V3, V4 at the intersection points P2, P3, P4. In this embodiment, the computation unit 202 will choose a maximum value among all sensing outputs triggered by the touch event, i.e., the maximum value V4 (which is derived form the intersection point P4 of the locating axis Y′ and the characteristic curve of the sensing output D4) among the intersection points between the locating axis Y0 and the characteristic curves of all sensing outputs. Assuming that the left side of the sensing electrode A1 is the origin point on the horizontal axis, the computation unit 202 thereby refers to hardware parameters, such as the sensing electrode width d1 and the distance d2 between two sensing electrodes, to derive a location X0 of the zero point Z3 of the characteristic curve of the sensing output D3 (which is previous to the characteristic curve of the sensing output D4) relative to an absolute zero axis Y0′, i.e., a center point between the sensing electrodes A3 and A4. This can be expressed as follows:

X0=(d1+d2)*3−d2*0.5 (1)

The computation unit 202 can thereby derive a location X (i.e., the center of the touch event) of the locating axis Y′ via the location X0 of the zero point Z3 of the characteristic curve of sensing output D3, the sensing output V3 at the intersection point P3 and the negative slope SP stored in the storage unit 201. This can be expressed as follows:

X=X0+V3*SP (2)

Since the curve around the zero point Z3 of the characteristic curve of the sensing output D3 has favorable linearity, applying equation (2) can derive the center position of the touch point quickly and accurately.

Please note that the aforementioned example is only a preferred embodiment of the present invention, and is not meant to be a limitation to the scope of the present invention. For example, the computation unit 202 can also choose a minimum value among all sensing outputs triggered by the touch event, i.e., the minimum value V2 (which is derived from the intersection point P2 of the locating axis Y′ and the characteristic curve of the sensing output D2) among the intersection points between the locating axis Y′ and the characteristic curves of all sensing outputs. The difference between this embodiment and the previous embodiment (which chooses the characteristic curve of the sensing output D3 prior to the characteristic curve of the sensing output D4 that has the maximum value V4 at the intersection point for computation) is that: in this embodiment, the computation unit 202 will choose the characteristic curve of the sensing output D3, which is next to the characteristic curve of the sensing output D2 having the minimum value V2 at the intersection point, for computation, and the computation unit 202 will utilize equation (1) and equation (2) as in the previous embodiment to derive the same result. No matter whether a minimum value or a maximum value is chosen among the intersection points of the locating axis Y′ and the characteristic curves of sensing outputs, the characteristic curve of the sensing output D3 is eventually utilized for computation.

In summary, regarding characteristic curves of sensing outputs whose slopes are negative around zero points, any method that references whether a chosen extreme value is a maximum value or a minimum value to utilize a characteristic curve prior to or following the characteristic curve of a sensing output with the extreme value and a related slope (negative in the previous two embodiments) corresponding to the chosen extreme value for determining a center position of a touch point, falls within the scope of the present invention.

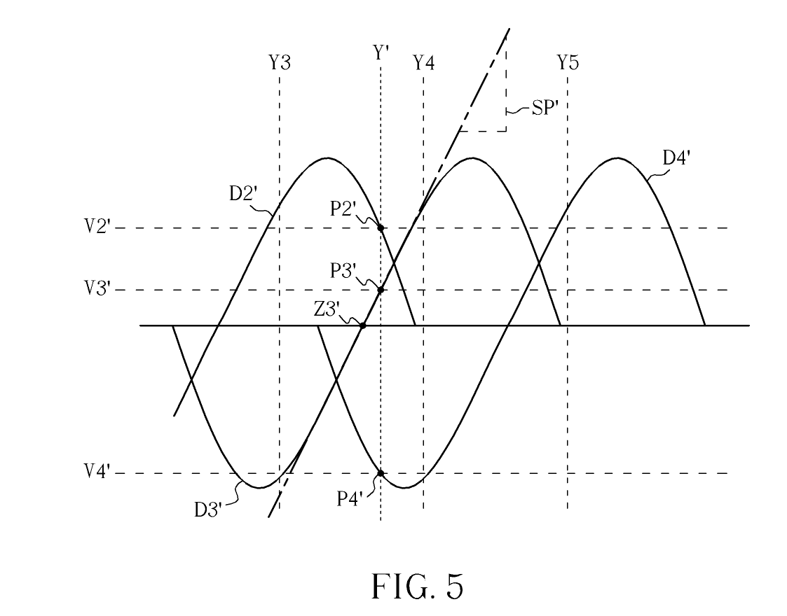

In addition, regarding characteristic curves having positive slopes around zero points due to different generation methods (as shown in FIG. 3), any method that references whether a chosen extreme value is a maximum value or a minimum value to utilize a characteristic curve following or prior to the characteristic curve of the sensing output with the extreme value and a related slope (i.e., a positive slope) corresponding to the extreme value for determining a center position of a touch point, falls within the scope of the present invention. Please refer to FIG. 5, which is a diagram of characteristic curves of partial sensing outputs of the touch panel 100 under the occurrence of a touch event according to another embodiment of the present invention. Compared with FIG. 4, characteristic curves of sensing outputs D2′, D3′ and D4′ in FIG. 5 are generated from differences of neighboring characteristic curves (i.e., S2−S1, S3−S2 and S4−S3). The computation unit 202 will find out a maximum value V2′ of the intersection point P2′ of the locating axis Y′ and the characteristic curve of sensing output D2′, and choose the characteristic curve of the sensing output D3′ next to the characteristic curve of the sensing output D2′, Next, the computation unit 202 will utilize hardware parameters such as the sensing electrode width d1 and the distance d2 between two sensing electrodes (in this example, a distance between centers of two neighboring sensing electrodes is d1+d2) to derive a location X0′ of the zero point Z3′ of the characteristic curve of the sensing output D3′, which can be expressed as follows:

X0′=(d1+d2)*3−d2*0.5 (3)

The computation unit 202 can thereby derive a location X′ (i.e., the center of the touch event) of the locating axis Y′ via the location X0′ of the zero point Z3′ of the characteristic curve of sensing output D3′, the sensing output V3′ at the intersection point P3′ and the positive slope SP′ stored in the storage unit 201, which can be expressed as follows:

X′=X0′+V3′*SP′ (4)

Likewise, the computation unit 202 can also choose a minimum value among all sensing outputs triggered by the touch event among the intersection points between the locating axis Y′ and the characteristic curves of all sensing outputs for computation, and the final result will still be the same. Related details can be easily understood by referring to previous paragraphs directed to FIG. 4, and therefore further description is omitted here for brevity.

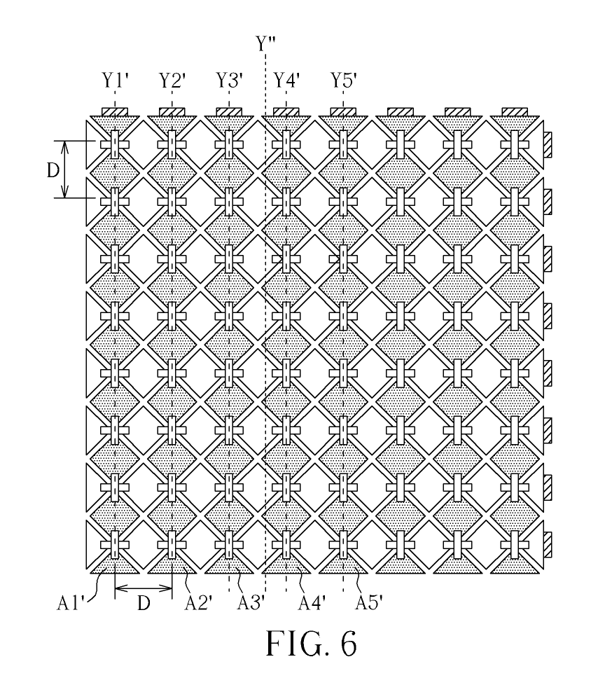

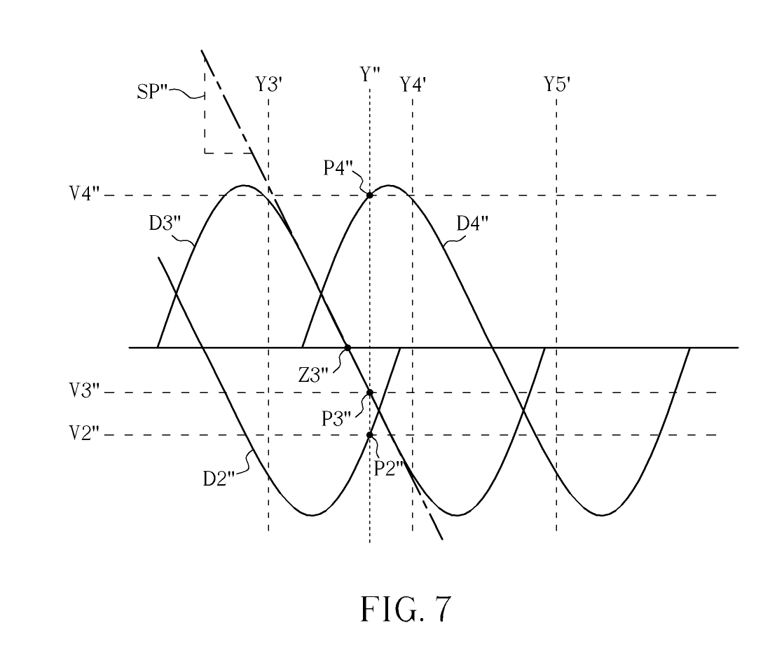

In a practical implementation, each sensing electrode will not be shaped like a bar as shown in FIG. 1. Please refer to FIG. 6, which is a diagram of a common touch panel 600 in a practical implementation. It can be seen from the figure that in order to process touch signals vertically and horizontally, the touch panel 600 utilizes multiple rhombuses to form a sensing electrode in a specific direction. This kind of design implementation does not influence the performance of the present invention, however. For example, assuming that the touch panel 600 has five sensing electrodes A1′˜A5′ whose centers are located on five locating axes Y1′˜Y5′, respectively, a distance between two neighboring sensing electrodes is D, and a touch event occurs at the locating axis Y″. Please refer to FIG. 7 in conjunction with FIG. 6. FIG. 7 is a diagram of characteristic curves of partial sensing outputs of the touch panel 600 under the occurrence of a touch event according to an embodiment of the present invention. It can be seen from the figure that the locating axis Y″ intersects characteristic curves of sensing outputs D2″, D3″ and D4″ corresponding to sensing electrodes A2″, A3″ and A4″ at intersection points P2″, P3″ and P4″, respectively. The location X0″ (a center between the sensing electrodes A3′ and A4′) of the zero point Z3″ of the characteristic curve of the sensing output D3″ relative to the locating axis Y1′ is derived, which can be expressed as follows:

X0″=D*3 (5)

Therefore, a location X (i.e., the center of the touch event) of the locating axis Y″ can be derived via the location X0″ of the zero point Z3″ of the characteristic curve of sensing output D3″, the sensing output V3″ at the intersection point P3″ and the negative slope SP″. This can be expressed as follows:

X″=X0″+V3″*SP″ (6)

From the descriptions above, via substantially identical computation processes, the present invention can determine a touch point on the touch panel 600 quickly and accurately. As related details about positive slope, negative slope, choosing maximum value or minimum value can be readily understood via referring to the previous descriptions, further details are omitted here for brevity.

In summary, the present invention provides a processing circuit capable of determining a touch point of a touch event on a touch panel quickly and accurately, by utilizing differences of sensing signals of sensing electrodes and choosing related data with good linearity for computation. The present invention can locate the center of a touch point accurately and save a great amount of resources as compared to those required by conventional computation.

Those skilled in the art will readily observe that numerous modifications and alterations of the device and method may be made while retaining the teachings of the invention.

What is claimed is:

1. A processing circuit for determining a touch point of a touch event on a touch control panel, wherein a plurality of sensing electrodes of the touch control panel generates a plurality of sensing signals in response to the touch event, respectively, and generates a plurality of sensing outputs according to differences between the plurality of sensing signals; the processing circuit comprising:
a storage unit, for storing a plurality of known parameters, wherein the plurality of known parameters comprises hardware parameters of at least one sensing electrode within the plurality of the sensing electrodes and signal parameters corresponding to at least one sensing output within the plurality of sensing outputs; and
a computation unit, coupled to the storage unit, for determining the touch point of the touch event according to the plurality of the sensing outputs and the plurality of known parameters.

2. The processing circuit of claim 1, wherein the hardware parameters of the sensing electrode comprise a distance between a center of the sensing electrode and a center of a neighboring sensing electrode.

3. The processing circuit of claim 1, wherein the signal parameters of the sensing electrode comprise a slope parameter.

4. The processing circuit of claim 1, wherein the computation unit chooses a first sensing output and a second sensing output from the plurality of sensing outputs, and determines a touch point of the touch event according to the first sensing output, the second sensing output and the known parameters; the first sensing output and the second sensing output respectively correspond to a first sensing electrode and a second sensing electrode neighboring to each other; and the first sensing output is an extreme value of the sensing outputs.

5. The processing circuit of claim 4, wherein the hardware parameters of the sensing electrode comprise a distance between a center of the sensing electrode and a center of a neighboring sensing electrode; and the signal parameters of the sensing electrode comprise a slope parameter.

6. The processing circuit of claim 5, wherein the computation unit determines a location of the second sensing electrode according to the distance between the center of the sensing electrode and the center of the neighboring sensing electrode, and determines the touch point of the touch event according to the location, the slope parameter and the second sensing output of the second electrode.

7. The processing circuit of claim 6, wherein the extreme value is a maximum value; and the slope parameter is a negative slope corresponding to the second sensing output.

8. The processing circuit of claim 6, wherein the extreme value is a minimum value; and the slope parameter is a negative slope corresponding to the second sensing output.

9. The processing circuit of claim 6, wherein the extreme value is a maximum value; and the slope parameter is a positive slope corresponding to the second sensing output.

10. The processing circuit of claim 6, wherein the extreme value is a minimum value; and the slope parameter is a positive slope corresponding to the second sensing output.

11. A processing method for determining a touch point of a touch event on a touch control panel, wherein a plurality of sensing electrodes of the touch control panel generates a plurality of sensing signals in response to the touch event, respectively, and generates a plurality of sensing outputs according to differences of the plurality of sensing signals; the processing method comprising:
storing a plurality of known parameters, wherein the plurality of known parameters comprises hardware parameters of at least one sensing electrode within the plurality of the sensing electrodes and signal parameters corresponding to at least one sensing output within the plurality of sensing outputs; and
determining the touch point of the touch event according to the plurality of the sensing outputs and the plurality of known parameters.

12. The processing method of claim 11, wherein the hardware parameters of the sensing electrode comprise a distance between a center of the sensing electrode and a center of a neighboring sensing electrode.

13. The processing method of claim 11, wherein the signal parameters of the sensing electrode comprise a slope parameter.

14. The processing method of claim 11, wherein the step of determining the touch point of the touch event according to the plurality of the sensing outputs and the plurality of known parameters comprise:
choosing a first sensing output and a second sensing output from the sensing outputs; and
determining a touch point of the touch event according to the first sensing output, the second sensing output and the known parameters;
wherein the first sensing output and second sensing output respectively correspond to a first sensing electrode and a second sensing electrode neighboring each other; and the first sensing output is an extreme value of the sensing outputs.

15. The processing method of claim 14, wherein the hardware parameters of the sensing electrode comprise a distance between a center of the sensing electrode and a center of a neighboring sensing electrode; and the signal parameters of the sensing electrode comprise a slope parameter.

16. The processing method of claim 15, wherein the step of determining the touch point of the touch event according to the plurality of the sensing outputs and the plurality of known parameters comprises:
determining a location of the second sensing electrode according to the distance between the center of the sensing electrode and the center of the neighboring sensing electrode; and
determining the touch point of the touch event according to the location, the slope parameter and the second sensing output of the second electrode.

17. The processing method of claim 16, wherein the extreme value is a maximum value; and the slope parameter is a negative slope corresponding to the second sensing output.

18. The processing method of claim 16, wherein the extreme value is a minimum value; and the slope parameter is a negative slope corresponding to the second sensing output.

19. The processing method of claim 16, wherein the extreme value is a maximum value; and the slope parameter is a positive slope corresponding to the second sensing output.

20. The processing method of claim 16, wherein the extreme value is a minimum value; and the slope parameter is a positive slope corresponding to the second sensing output.
